(19) United States
(12) Patent Application Publication
(10) Pub. No.: US 2012/0302205 A1
(43) Pub. Date: Nov. 29, 2012

(54) Method and system for the online charging of a subscriber, program and computer program product

(75) Inventor: Markus Breitbach, Bonn (DE)

(73) Assignee: DEUTSCHE TELEKOM AG, Bonn (DE)

(21) Appl. No.: 13/479,399

(22) Filed: May 24, 2012

(30) Foreign Application Priority Data
May 24, 2011 (DE) 10 2011 103 010.0

(51) Int. Cl. H04W 4/26

(52) U.S. Cl. 455/406

(57) ABSTRACT

A method for charging a subscriber using a telecommunications service in a telecommunications network according to a contract with respect to the telecommunications service includes: transmitting, by a billing entity, charging information to a data traffic management entity; monitoring, by the data traffic management entity, the flow of data which is used by the subscriber with respect to the telecommunications service and determining a current data usage volume of the subscriber; comparing, by the data traffic management entity, the current data usage volume of the subscriber with a current upper data usage threshold; and modifying the standard service usage pattern of the telecommunications service if the current data usage volume and the current upper data usage threshold satisfy a predetermined condition.

### CROSS-REFERENCE TO RELATED APPLICATIONS

This patent application claims priority to German Patent Application No. DE 10 2011 103 010.0, filed in Germany on May 24, 2011.

### FIELD

The present invention relates to a method and to a system for the online charging of a subscriber, the subscriber using a telecommunications service in a telecommunications network according to a contract with respect to the telecommunications service. The present invention also relates to a program and to a computer program product.

The invention generally relates to the charging of a subscriber of a telecommunications network, such as a public mobile terrestrial network. The subscriber is preferably a mobile subscriber with a mobile radio unit, such as a cellular telephone, a smartphone, a PDA (personal digital assistant) or a personal navigation device or the like. In the following, the mobile radio unit will also be called the subscriber. In the context of this invention, the mobile radio unit does not necessarily have to be a movable device; it can also be a fixedly installed device which uses mobile communications technology based on a public mobile terrestrial network, for example.

### BACKGROUND

At present, one possibility of using mobile telecommunications services (i.e. services based on the use of mobile telecommunications networks to supply mobile radio units) is the use of so-called flat-rate tariffs which make it possible for the subscriber to be connected to the telecommunications network in a manner unlimited by time or data volume.

Flat-rate tariffs or telecommunications contracts of this type typically include the provision that beyond a specific maximum data volume, only a reduced transmission bandwidth is available or a transmission is only possible according to other telecommunications standards with a reduced bandwidth. Tariffs of this type are also known as fair flat-rate tariffs.

Typically, it is further specified in these tariffs that the user or subscriber has a specific maximum data transmission volume (without a reduced bandwidth), for example 1 GB per first time interval, typically one month, and that at the start of this first time interval, the subscriber is allowed to use this maximum data transmission volume for this first time interval without any restrictions. Consequently, an irregular service usage pattern ensues, i.e. in the first half of the first time interval (typically in the first half of the month), a higher data volume or a higher network traffic is recorded by the telecommunications network than in the second half of the first time interval (i.e. in this example, in the second half of the month). This means that either the network resources have to meet the demands of the higher data volume or the demands of the higher network traffic, thereby entailing higher costs, or the service availability of the network subscribers has to be reduced.

### SUMMARY

In an embodiment, the present invention provides a method for charging a subscriber using a telecommunications service in a telecommunications network according to a contract with respect to the telecommunications service. The method includes: transmitting, by a billing entity, charging information to a data traffic management entity; monitoring, by the data traffic management entity, the flow of data which is used by the subscriber with respect to the telecommunications service and determining a current data usage volume of the subscriber; comparing, by the data traffic management entity, the current data usage volume of the subscriber with a current upper data usage threshold; and modifying the standard service usage pattern of the telecommunications service if the current data usage volume and the current upper data usage threshold satisfy a predetermined condition. The current upper data usage threshold is derived from the charging information. The current upper data usage threshold indicates a current maximum level of data which can be used by the subscriber with respect to the telecommunications service. The telecommunications service has a standard service usage pattern. The current upper data usage threshold is updated based on a purchased maximum data volume corresponding to a first time interval. The update interval of the current upper data usage threshold is based on a second time interval. The second time interval is shorter than the first time interval.

### BRIEF DESCRIPTION OF THE DRAWINGS

FIG. 1 schematically shows a block diagram of a system according to an embodiment of the present invention.

FIG. 2 schematically shows an exemplary data usage scenario of a conventional fair flat-rate tariff.

FIGS. 3 to 6 schematically show exemplary data usage scenarios of a fair flat-rate tariff according to different embodiments of the present invention.

FIG. 7 schematically shows a processing sequence according to embodiments of the present invention.

FIG. 8 schematically shows an alternative processing sequence according to an embodiment of the present invention.

### DETAILED DESCRIPTION

In an embodiment, the present invention enables a balanced use of the network capacities associated with the use of flat-rate tariffs.

In an embodiment, the present invention provides a method for online charging of a subscriber, the subscriber using a telecommunications service in a telecommunications network, and the use of the network by the subscriber being hindered as little as possible by service restrictions due to an unused data volume, while at the same time allowing a balanced full capacity utilization of the network. In a further embodiment, a system is provided for the online charging of a subscriber.

In an embodiment, a method for the online charging of a subscriber is provided, the subscriber using a telecommunications service in a telecommunications network according to a contract with respect to the telecommunications service. The method includes:

transmission by a billing entity of charging information to a data traffic management entity, a current upper data usage threshold being derived from the charging information, the current upper data usage threshold indicating a current maximum level of data which can be used by the subscriber with respect to the telecommunications service, and the telecommunications service having a standard service usage pattern,

monitoring by the data traffic management entity of the flow of data which is used by the subscriber with respect to the telecommunications service, and determining the current data usage volume of the subscriber,

comparison by the data traffic management entity of the current data usage volume of the subscriber with the current upper data usage threshold, and

modification of the standard service usage pattern of the telecommunications service if the current data usage volume and the current upper data usage threshold satisfy a predetermined condition, the current upper data usage threshold being updated based on a purchased maximum data volume with respect to a first time interval, the update interval of the current upper data usage threshold being based on a second time interval, the second time interval being shorter than the first time interval.

It is advantageously possible that a balanced full network utilization or network usage by subscribers can be achieved with a flat-rate tariff. In particular, the balanced network usage relates to a balanced full network utilization during the first time interval which typically corresponds to a charging period (which is typically one month or several months or weeks, although it can also be one week or even less, for example three days or five days). This means that the restrictions for subscribers (i.e. modification of the standard service usage pattern) who have used up the maximum data volume in a given contractual context are no longer concentrated in the second half (or towards the end) of the first time interval (or charging period), but are equally probable during the entire first time interval.

As a result, it is advantageously possible that the telecommunications network can be configured and used in an efficient manner.

In an embodiment, the current upper data usage threshold is updated by rising (or by increasing) during the contract term of the subscriber.

In a first exemplary embodiment, the current upper data usage threshold is updated by continuously increasing the value of the current upper data usage threshold. In a second exemplary embodiment, the current upper data usage threshold to be updated by adding an increment value. The increment value is obtained by the following method, for example: in a first step, the purchased maximum data rate is calculated, based on the contractual situation of the subscriber concerned, i.e. the purchased maximum data volume is divided by the first time interval (typically the charging period), for example 1 GB (one gigabyte) per month. In a second step, this maximum data rate is based on the second time interval, i.e. on the update interval of the current upper data usage threshold. Assuming that one month has an average of 30 days, then a purchased maximum data rate of this type corresponds to approximately 1.389 MB (1.389 megabytes) per hour or approximately 23.148 kB (23.148 kilobytes) per minute or approximately 386 bytes per second (assuming 1 kB=10³ bytes, 1 MB=10⁶ bytes, 1 GB=10⁹ bytes). Depending on the update interval or the second time interval, according to the second variant of the present invention, the current upper data usage threshold is raised, for example by 386 bytes per second, or by 23.148 kB per minute, or by 1.389 MB per hour.

According to both these exemplary embodiments, by updating the current upper data usage threshold, it is possible, since this threshold is raised, either continuously or quasi-continuously (in that a relatively low increment value is added to the previous value and is updated relatively frequently, at least compared to the first time interval), for the subscribers to be able to be provided with the purchased data volume on a finely divided time basis, without the used data volume having to be stored in the data traffic management entity for every user at every moment.

For periods in which no data connection is active or in which no data volume is used with reference to a specific contract, “updating the upper data usage threshold” does not necessarily include the updating, individually for this specific contract, of a storage location of a computer memory every time the second time interval has expired. In an embodiment, the upper data usage threshold is updated only if a data connection is active or only if data volume is used with respect to the specific contract. This updating process is preferably carried out by performing a simple calculation based on timing information (for example by counting the number of second time intervals) or based on a time difference at the start of the contract, for example by multiplying the timing information by static information, such as the maximum data rate per second time interval. Consequently, it is advantageously possible for the system load to be reduced for the monitoring and tracking of the upper data usage threshold, because only one item of (continuously varying) timing information can be used for a large number of specific contracts. Thus for example, the timing information for a specific contract can commence on the day of the start of the contract for all contracts which commence on the same day, so that it is possible to avoid all contracts being tracked and updated if contracts are not active (i.e. they have an active data connection).

In an embodiment, a transparent charging and network access system can be provided so that it is possible for a subscriber to find out whether or not a restriction of network access, i.e. a modification of the standard service usage pattern of the telecommunications service (for example a limitation of the available bandwidth for the specific subscriber, because the maximum data volume has been used up), is justified.

In an embodiment, if the second time interval exceeds one second or ten seconds, the current upper data usage threshold is not updated at the same time for all subscribers. This allows a balanced full utilization of the network capacity, because the updating of the current upper data usage threshold means that data volume becomes free for use by a subscriber.

In an embodiment, a minimum time or a minimum time interval (hereafter also called the third time interval) must elapse before a once implemented modification of the standard service usage pattern of the telecommunications service (for example a limitation of the available bandwidth for the specific subscriber, because the maximum data volume has been used up) is reversed again. This is advantageous because, in this manner, it is possible to prevent the modification of the standard service usage pattern of the telecommunications service having to be repeatedly carried out and reversed again in comparatively short time intervals in the telecommunications network, which is associated with an increased signalling expense and therefore the frequency thereof is to be restricted as far as possible in order to avoid network overload situations.

In an embodiment, a current lower data usage threshold is determined from the charging information, the current lower data usage threshold indicating a current minimum level of data which can be used by the subscriber. The method includes the following steps:

the data traffic management entity compares the current data usage volume of the subscriber with the current lower data usage threshold, and

the data traffic management entity adapts the current data usage volume to the current lower data usage threshold if the current data usage volume is less than the current lower data usage threshold, the current lower data usage threshold being updated based on the purchased maximum data volume with respect to the first time interval, the update interval of the current lower data usage threshold being based on the second time interval and the second time interval being shorter than the first time interval.

As a result, usage peaks, and therefore peaks in the network load can be avoided by subscribers who have not used their purchased data volume for a relatively long time (and therefore have a relatively great difference between a relatively low data volume usage and a relatively high current upper data usage threshold).

In a further embodiment, with respect to the current lower data usage threshold, the current lower data usage threshold is updated

either by continuously increasing the current lower data usage threshold, or

by adding an increment value to the preceding current lower data usage threshold (analogously to the manner described with respect to the current upper data usage threshold).

For periods in which no data connection is active or in which no data volume is used with respect to a specific contract, “updating the lower data usage threshold” does not necessarily include the updating, individually for this specific contract, of a storage location of a computer memory every time the second time interval has expired. In an embodiment, the lower data usage threshold is updated only if a data connection is active or only if data volume is used with respect to the specific contract, preferably as described with respect to the upper data usage threshold.

In an embodiment, the predetermined condition of the current data usage volume and of the current upper data usage threshold includes:

the current data usage volume exceeds the current upper data usage threshold, or

the current data usage volume differs to a lesser extent from the current upper data usage threshold than a predetermined value.

As a result, the standard service usage pattern is modified (for example, limitation of the usable bandwidth for a specific subscriber and/or reduction of the service quality parameters of the data traffic with respect to the specific subscriber)

if the current data usage volume reaches the current upper data usage threshold, or

before this event, for example to indicate to the subscriber that the purchased maximum volume of data will soon be used up.

In a further embodiment, the current upper data usage threshold and/or the current lower data usage threshold is/are updated by increasing during the contract term of the subscriber.

As a result, a transparent charging and network access system can be provided so that it is possible for a subscriber to find out whether or not a restriction of network access is justified.

In a further embodiment, at the start of the contract term relating to the telecommunications service, the current upper data usage threshold corresponds to the initial data volume which is used by the subscriber, and at the end of the contract term, the current upper data usage threshold corresponds to an end data volume, the end data volume corresponding to:

the purchased maximum data volume multiplied by the number of first time intervals of the contract, or

the total of the initial data volume on the one hand and the purchased maximum data volume multiplied by the number of first time intervals of the contract on the other.

As a result, a fair and transparent charging scheme can be made available to the subscriber.

In a further embodiment, the standard service usage pattern is modified by the use of a reduced service usage pattern, the reduced service usage pattern having:

a reduced bandwidth compared to the standard service usage pattern and/or

a reduced priority of the data transmission compared to the standard service usage pattern.

As a result, the network usage of the subscriber can be restricted to a contractually agreed level.

In a further embodiment, the first time interval corresponds to either one month or one week, the second time interval being the same length as or shorter than:

one second,

one minute,

one hour, or

24 hours,

or the first time interval corresponds to one day, the second time interval being the same length as or shorter than:

one second,

one minute, or

one hour.

For both examples, the second time interval is much shorter than the first time interval. In various embodiments:

the first time interval is at least 5 times as long as the second time interval, or

the first time interval is at least 10 times as long as the second time interval, or

the first time interval is at least 20 times as long as the second time interval, or

the first time interval is at least 50 times as long as the second time interval, or

the first time interval is at least 100 times as long as the second time interval, or

the first time interval is at least 1000 times as long as the second time interval.

In a further embodiment, the online charging of the subscriber with respect to another telecommunications service in the telecommunications network is carried out. The method includes the following steps:

transmission by the billing entity of further charging information to the data traffic management entity, a current further upper data usage threshold being determined from the further charging information, the current further upper data usage threshold indicating a current maximum level of data which can be used by the subscriber with respect to the further telecommunications service, the further telecommunications service having a further standard service usage pattern,

monitoring by the data traffic management entity of the flow of data which is used by the subscriber with respect to the further telecommunications service, and determining the current further data usage volume of the subscriber,

comparison by the data traffic management entity of the current further data usage volume of the subscriber with the current further upper data usage threshold, and

modification of the standard service usage pattern of the further telecommunications service if the current further data usage volume and the current further upper data usage threshold satisfy a predetermined further condition, the current further upper data usage threshold being updated based on a further purchased maximum data volume with respect to the first time interval, the update interval of the current further upper data usage threshold being based on the second time interval, the second time interval being shorter than the first time interval.

In a further embodiment, a system is provided for the online charging of a subscriber, the subscriber using a telecommunications service in a telecommunications network according to a contract with respect to the telecommunications service. The system includes a billing entity and a data traffic management entity with the system being configured such that

the billing entity transmits charging information to the data traffic management entity, a current upper data usage threshold being determined from the charging information, the current upper data usage threshold indicating a current maximum level of data which can be used by the subscriber with respect to the telecommunications service, the telecommunications service having a standard service usage pattern,

the data traffic management entity monitors the flow of data which is used by the subscriber with respect to the telecommunications service, and determines the current data usage volume of the subscriber,

the data traffic management entity compares the current data usage volume of the subscriber with the current upper data usage threshold, and

the standard service usage pattern of the telecommunications service can be modified if the current data usage volume and the current upper data usage threshold satisfy a predetermined condition, the current upper data usage threshold being updated based on a purchased maximum data volume with respect to a first time interval, the update interval of the current upper data usage threshold being based on a second time interval, the second time interval being shorter than the first time interval.

Using this system, a balanced network usage can be achieved by subscribers with a flat-rate tariff. This balanced network usage by these subscribers relates to a balanced full network utilization during the first time interval.

In a further embodiment, a program is provided having a program code which, when implemented on a computer, occasions the computer to implement a method according to an embodiment of the present invention.

In a further embodiment, a computer program product is provided for the online charging of a subscriber, including a computer program which is stored in a memory, the computer program including a program code which, when implemented on a computer, occasions the computer to implement a method according to an embodiment of the present invention.

These and other characteristics, features and advantages of the present invention become apparent from the following detailed description which illustrates the principles of the present invention in conjunction with the exemplary figures. This description is to be considered merely as an example, without thereby restricting the scope of protection of the present invention. The figures and the reference numerals relate to the accompanying drawings.

The present invention will be described with reference to specific exemplary embodiments and specific drawings. However, the invention is not restricted to these embodiments and drawings, but is limited only by the claims. The drawings are merely schematic and are non-limiting. In the drawings, for illustration purpose, some elements may have been shown oversized and not true to scale.

If an indefinite or definite article is used with respect to the singular of a noun, for example “a” or “the”, this will also include the plural of this noun, unless indicated otherwise.

Furthermore, expressions such as “the first, the second” etc. are used in the description and in the claims to differentiate between similar elements. This does not necessarily have to be the description of a sequential or chronological order. These expressions are interchangeable under appropriate conditions and the described embodiments are capable of operating in sequences other than those which have been described.

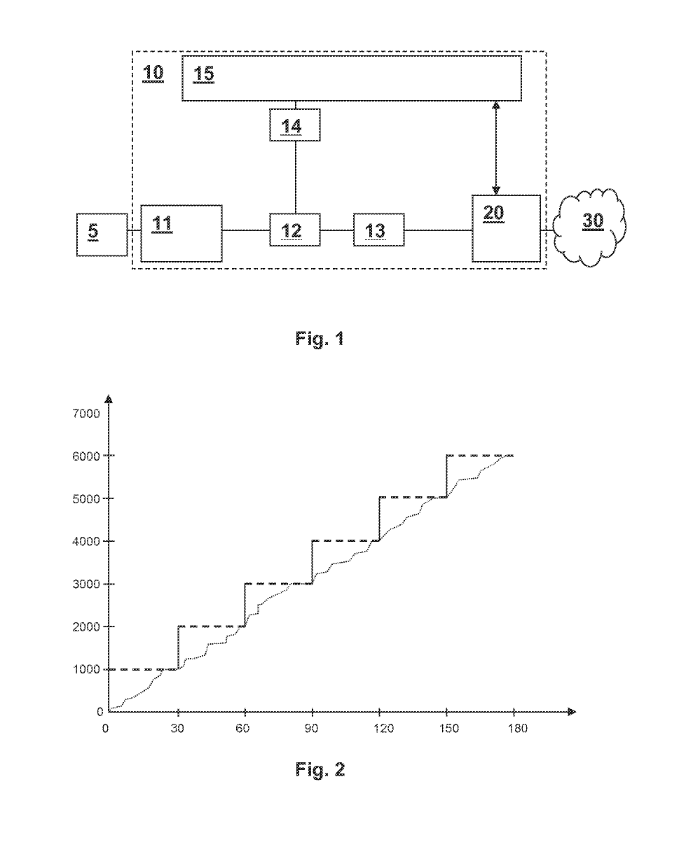

FIG. 1 schematically shows a block diagram according to the present invention. A subscriber 5 uses a telecommunications service in a telecommunications network 10. The telecommunications network 10 provides, for example, a service for downloading data from the Internet 30.

The telecommunications network 10 includes a radio access network 11 and, for example, a serving GPRS support node (SGSN) 12, a gateway GPRS support node (GGSN) 13, a home location register 14 and a billing entity 15 or a billing system 15. The telecommunications network 10 further includes a data traffic management entity 20.

The data traffic management entity 20 includes a service control engine to control the access of the subscriber 5 to the telecommunications service of the telecommunications network 10.

FIG. 2 schematically shows an exemplary data usage scenario of a conventional fair flat-rate tariff. Plotted on the abscissa is the time in days which have passed during the contract term of the subscriber 5 with respect to the subscribed telecommunications service. Plotted on the ordinate is the data volume, for example in megabytes. It can be seen that the schematically illustrated contract of the subscriber 5 includes a usable data volume of 1000 MB per month of the contract. At the start of the first month (i.e. at a number of 0 days), the possible usable (or “free”) data volume is 1000 MB for this subscriber 5, this data volume being indicated by a horizontal dashed line running parallel to the abscissa from “0” days to “30” days. The subscriber uses usable data volume (which is represented by a dotted data usage development line) and reaches the maximum usable data volume before the end of the first charging period, in other words the first month; i.e. at the end of the first month (approximately during the last 4 days of the first month), a usable data volume (or a high bandwidth data volume) is no longer available for the considered contract for the subscriber. At the start of the next charging period, i.e. of the second month which is shown on the abscissa between “30 days” and “60 days”, the subscriber 5 has a further usable data volume of 1000 MB (this data volume being indicated by a further horizontal dashed line running from “30 days” to “60 days” parallel to the abscissa).

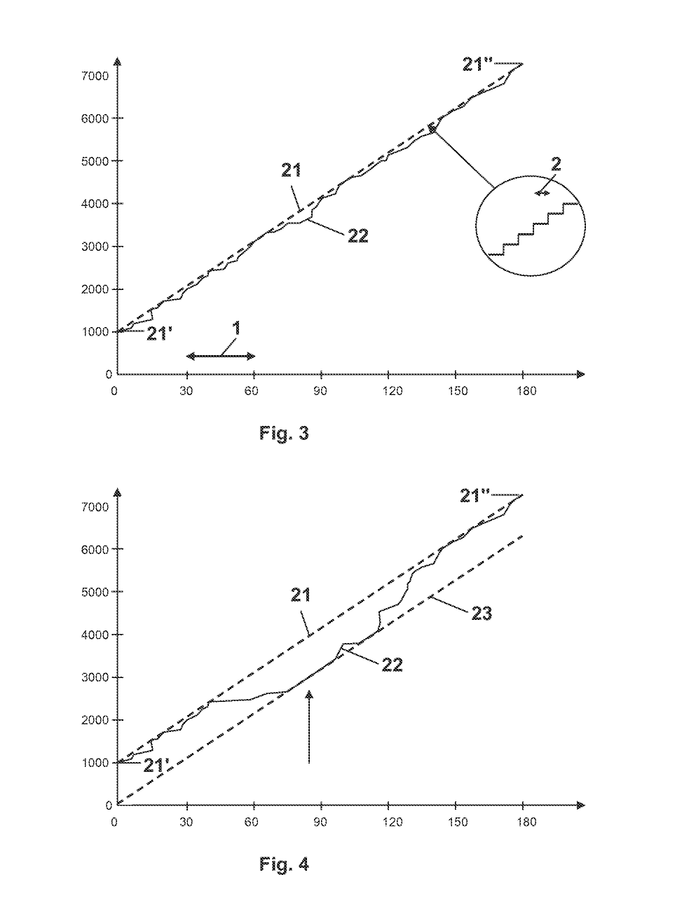

FIGS. 3 to 6 schematically show exemplary data usage scenarios of a fair flat-rate tariff according to different embodiments of the present invention. In all these figures, the time, indicated by the days which have passed during the contract term of the subscriber 5 with respect to the subscribed telecommunications service, is plotted on the abscissa. The data volume is plotted on the ordinate, for example in megabytes.

Charging information is transmitted from the billing entity 15 to the data traffic management entity 20. A current upper data usage threshold 21 is derived from the charging information. The current upper data usage threshold 21 indicates a current maximum level of data which can be used by the subscriber 5 with respect to the telecommunications service. In FIGS. 3 to 6, the current upper data usage threshold 21 is indicated by a dashed line and by reference numeral 21. The current upper data usage threshold 21 starts at an initial value 21′ (hereafter also called initial data volume 21′) which corresponds to the current upper data usage threshold 21 at the start of the considered period, for example a contractual period, and ends at an end data volume 21″. In the illustrated examples, this period is always assumed as being 6 months, i.e. approximately 180 days. Naturally, other periods (also subject to the first time interval) are also possible according to embodiments of the present invention. The telecommunications service has a standard service usage pattern, for example defined by a maximum bandwidth or by a quality service parameter.

According to the method in an embodiment, the data traffic management entity monitors the flow of data (from the telecommunications network 10 or to the telecommunications network 10) which is used by the subscriber 5 with respect to the telecommunications service, and determines the current data usage volume 22 of the subscriber 5. Furthermore, the data traffic management entity 20 compares the current data usage volume 22 of the subscriber 5 with the current upper data usage threshold 21 and modifies the standard service usage pattern of the telecommunications service if the current data usage volume 22 and the current upper data usage threshold 21 satisfy a predetermined condition, in particular if the current data usage volume 22 exceeds the current upper data usage threshold 21. In an embodiment, a minimum time or a minimum time interval must pass in terms of a third time interval, before a once implemented modification of the standard service usage pattern of the telecommunications service (for example a limitation of the available bandwidth for the specific subscriber, because the maximum data volume has been used up) is reversed again. This produces a type of hysteresis effect which means that it is advantageously possible to prevent the standard service usage pattern of the telecommunications service from having to be repeatedly modified in relatively short time intervals in the telecommunications network and subsequently reversed again. Thus, it is possible to restrict the signalling expense associated with the modification of the standard service usage pattern and the reversal of this modification.

In an embodiment, the current upper data usage threshold 21 is updated based on a purchased maximum data volume with respect to a first time interval, the update interval of the current upper data usage threshold 21 being based on a second time interval and the second time interval being shorter and particularly much shorter than the first time interval. This is shown in FIG. 3. It can be seen that the current upper data usage threshold 21 is updated by an increase during the contract term (in the example from “0 days” to “180 days”, i.e. 6 months). This can either be realized by continuously updating the current upper data usage threshold 21 or by quasi-continuously updating the current upper data usage threshold 21, as is schematically illustrated in FIG. 3 by an enlarged view of the current upper data usage threshold 21, containing the second time interval 2. The second time interval 2 is shorter than the first time interval 1, preferably at least 5 times shorter, more preferably at least 10 times shorter, most particularly preferably at least 20 times shorter and even more preferably at least 100 times shorter.

In FIG. 3, the current upper data usage threshold 21 is the only limit of the current data usage volume 22, i.e. by not using the data volume for a relatively long time, a subscriber 5 can immediately use a relatively large data volume at once and, as a result, can produce network usage peaks. This is not desired by the network operator.

FIG. 4 schematically shows a further exemplary data usage scenario of a fair flat-rate tariff according to a further embodiment of the present invention. FIG. 4 also shows a current lower data usage threshold 23, in other words, a subscriber 5 cannot accumulate an amount of usable data volume (which the subscriber can use immediately), which exceeds the division between the current upper data usage threshold 21 and the current lower data usage threshold 23. In the example of FIG. 4, this is, for example 1000 MB, i.e. the same as the usable data volume per month.

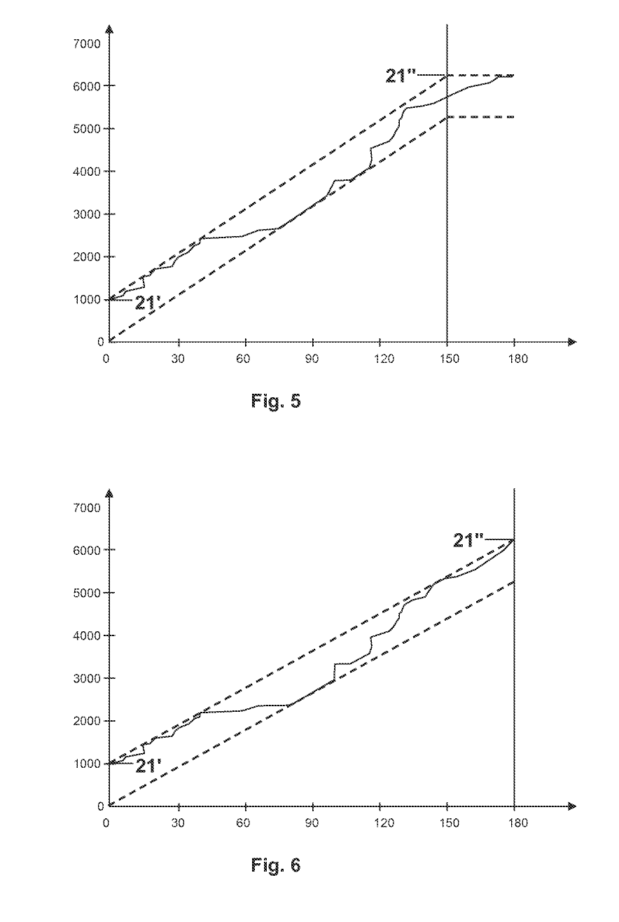

FIG. 5 schematically shows a further exemplary data usage scenario of a fair flat-rate tariff according to a further embodiment of the present invention. According to this embodiment, no further increase in the available data volume is realized during the last month of the contract term. This is because the contractually available data volume (end data volume 21″) of, for example 6 times 1000 MB (at a monthly data rate of 1000 MB) has already been reached after 5 months (or approximately 150 days) due to the initial possibility (initial data volume 21′) of using 1000 MB during the first month.

FIG. 6 schematically shows a further exemplary data usage scenario of a fair flat-rate tariff according to a further embodiment of the present invention. According to this embodiment, there is a limit of the maximum contractually available data volume of, for example 6 times 1000 MB (at a monthly data rate of 1000 MB), i.e. 6 GB for approximately 180 days of the contract, as well as an initially usable data volume of 1000 MB, but during the last month of the contract term, there is no further increase due to the reduced total data rate during the previous months. The increase in the current upper data usage threshold 21 is 5000 MB divided by 6 months (i.e. approximately 833 MB per additional month) and it starts at a 1000 MB data rate. In the example of FIG. 6, a current lower data usage threshold 23 also increases at a rate of 5000 MB divided by 6 months, i.e. the subscriber can use 1000 MB per any period of a month at any time during the contract.

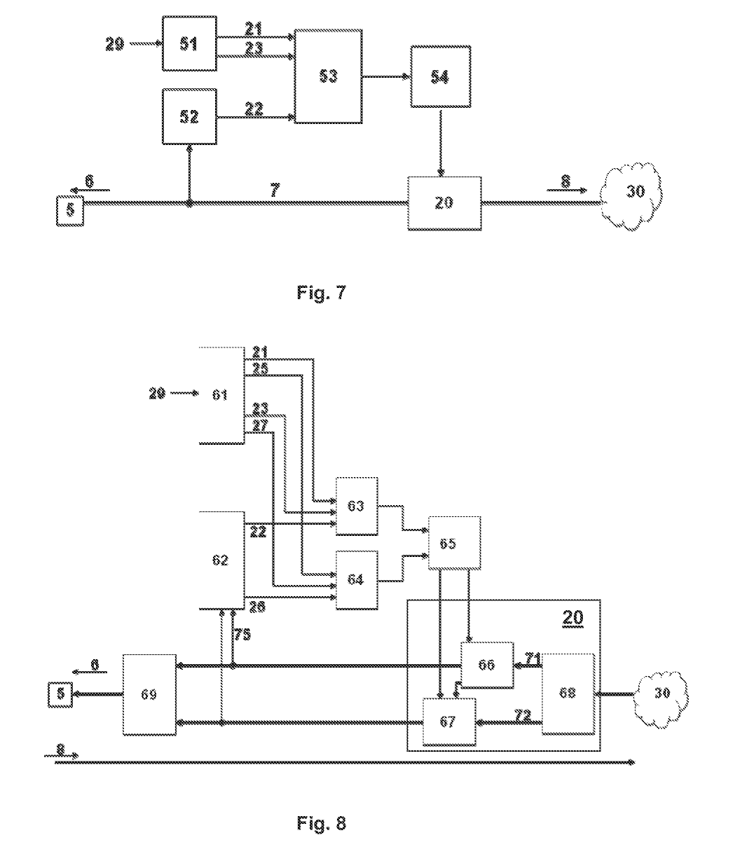

The processing sequence which results in the achievement of the method according to the invention for the online charging of the subscriber 5 according to FIGS. 4, 5 and 6 (i.e. comprising not only a current upper data usage threshold 21 but also a current upper data usage threshold 21 and a current lower data usage threshold 23) is shown schematically in FIG. 7. A user or subscriber 5 is connected by the telecommunications network to a source 30 of requested information, such as an Internet server. The subscriber 5 receives a downlink flow of data 6 and can send an uplink flow of data 8. An item of information about time 29 is provided in a first step 51 of the method. An item of information concerning or indicating the current data usage volume 22 is made available in a second step 52. In the first step 51, the current upper data usage threshold 21 and the current lower data usage threshold 23 are generated and are made available to a third step 53. Furthermore, in the second step 52, the current data usage volume 22 is generated and is also made available to the third step 53. In the third step 53, the current data usage volume 22 is preferably compared with both the current upper data usage threshold 21 and the current lower data usage threshold 23 and in a fourth step 54, a decision is made whether the standard service usage pattern is changed, because the current data usage volume 22 and the current upper data usage threshold 21 satisfy a predetermined condition, for example that the current data usage volume 22 exceeds the current upper data usage threshold 21 or the current data usage volume 22 differs to a lesser extent from the current upper data usage threshold 21 than a predetermined value. If a predetermined condition of this type is satisfied, the data traffic management entity 20 changes the standard service usage pattern with respect to the flow of data 7 to the subscriber 5.

In a further embodiment, which is shown schematically in FIG. 8, the online charging of the subscriber is also carried out with respect to a further telecommunications service in the telecommunications network 10, i.e. in addition to the online charging with respect to the telecommunications service and to the associated flow of data 7, to which FIGS. 3 to 7 relate. The further telecommunications service has a further standard service usage pattern. The billing entity 15 transmits further charging information to the data traffic management entity 20. A current further upper data usage threshold 25 is derived from the further charging information, the current further upper data usage threshold 25 indicating a current maximum level of data which can be used by the subscriber 5 with respect to the further telecommunications service. The data traffic management entity 20 monitors the flow of data which is used by the subscriber 5 with respect to the further telecommunications service. Furthermore, a current further data usage volume 26 of the subscriber 5 is determined and the data traffic management entity 20 compares the current further data usage volume 26 of the subscriber 5 with the current further upper data usage threshold 25. The further standard service usage pattern of the further telecommunications service is modified if the current further data usage volume 26 and the current further upper data usage threshold 25 satisfy a predetermined further condition, the current further upper data usage threshold 25 being updated based on a further purchased maximum data volume with respect to the first time interval, the update interval of the current further upper data usage threshold 25 being based on the second time interval, the second time interval being shorter than the first time interval.

In the example shown in FIG. 8, the telecommunications service and the further telecommunications service relate to different priorities of the data flows. In the downlink direction 6 from the Internet 30 to the subscriber 5, a data flow dividing entity 68 (preferably part of the data traffic management entity 20) divides a first flow of data (indicated by reference numeral 71) having a first priority from a second flow of data (indicated by reference numeral 72) having a second priority. The subscriber 5 receives a downlink data flow 6 and can send an uplink data flow 8. Data traffic management of the first data flow 71 can be carried out by a first data traffic management sub-entity 66 and data traffic management of the second data flow 72 can be carried out by a second data traffic management sub-entity 67.

An item of information about time 29 is made available to a first step 61 of the method. An item of information concerning or indicating the current data usage volume 22 (of the first telecommunications service) and an item of information concerning or indicating the current further data usage volume 26 (of the second telecommunications service) is made available in a second step 62 of the method. In the first step 61, the current upper data usage threshold 21 (of the first telecommunications service) and the current lower data usage threshold 23 (of the first telecommunications service) are generated and are made available to a third step 63. Correspondingly, in the first step 61, the current further upper data usage threshold 25 (of the second telecommunications service) and the current further lower data usage threshold 27 (of the second telecommunications service) are generated and are made available to a fourth step 64. Furthermore, in the second step 62, the current data usage volume 22 is generated and is made available to the third step 63. Furthermore, in the second step 62, the current further data usage volume 26 is generated and is made available to the fourth step 64. In the third step 63, the current data usage volume 22 is preferably compared with both the current upper data usage threshold 21 and with the current lower data usage threshold 23. In the fourth step 64, the current further data usage volume 26 is preferably compared with both the current further upper data usage threshold 25 and with the current further lower data usage threshold 27. In a fifth step 65, a decision is made whether the standard service usage pattern (and/or the further standard service usage pattern) is changed (by the first data traffic management sub-entity 66 and/or by the second data traffic management sub-entity 67), because the current data usage volume 22 and the current upper data usage threshold 21 satisfy a predetermined condition and/or because the current further data usage volume 26 and the current further upper data usage threshold 25 satisfy a further predetermined condition. If a predetermined condition of this type or a further predetermined condition is satisfied, the data traffic management entity 20 changes the standard service usage pattern or the further standard service usage pattern with respect to the flow of data 7 to the subscriber 5.

1-12. (canceled)

13. A method for charging a subscriber using a telecommunications service in a telecommunications network according to a contract with respect to the telecommunications service, the method comprising:
transmitting, by a billing entity, charging information to a data traffic management entity, wherein a current upper data usage threshold is derived from the charging information, wherein the current upper data usage threshold indicates a current maximum level of data which can be used by the subscriber with respect to the telecommunications service, and wherein the telecommunications service has a standard service usage pattern;
monitoring, by the data traffic management entity, the flow of data which is used by the subscriber with respect to the telecommunications service and determining a current data usage volume of the subscriber,
comparing, by the data traffic management entity, the current data usage volume of the subscriber with the current upper data usage threshold; and
modifying the standard, service usage pattern of the telecommunications service if the current data usage volume and the current upper data usage threshold satisfy a predetermined condition;
wherein the current upper data usage threshold is updated based on a purchased maximum data volume corresponding to a first time interval, wherein the update interval of the current upper data usage threshold is based on a second time interval, and wherein the second time interval is shorter than the first time interval.

14. The method according to claim 13, wherein a current lower data usage threshold is determined from the charging information,
wherein the current lower data usage threshold indicates a current minimum level of data which can be used by the subscriber,
wherein the method further comprises:
comparing, by the data traffic management entity, the current data usage volume of the subscriber with the current lower data usage threshold, and
adapting, by the data traffic management entity, the current data usage volume to the current lower data usage threshold if the current data usage volume is less than the current lower data usage threshold,
wherein the current lower data usage threshold is updated based on the purchased maximum data volume with respect to the first time interval, and
wherein the update interval of the current lower data usage threshold is based on the second time interval.

15. The method according to claim 14, wherein at least one of the current upper data usage threshold and the current lower data usage threshold is updated by increasing during a contract term of the subscriber.

16. The method according to claim 13, wherein the predetermined condition of the current data usage volume and of the current upper data usage threshold comprises at least one of:
the current data usage volume exceeds the current upper data usage threshold; and
the current data usage volume differs from the current upper data usage threshold to a lesser extent than a predetermined value.

17. The method according to claim 13, wherein at the start of a contract term relating to the telecommunications service, the current upper data usage threshold corresponds to an initial data volume which is used by the subscriber, and at the end of the contract term, the current upper data usage threshold corresponds to an end data volume, the end data volume corresponding to at least one of:
the purchased maximum data volume multiplied by the number of first time intervals of the contract; and
the total of the purchased maximum data volume multiplied by the number of first time intervals of the contract and the initial data volume.

18. The method according to claim 13, wherein modifying the standard service usage pattern of the telecommunications service further comprises at least one of:
reducing bandwidth relative to the standard service usage pattern; and
reducing priority of data transmission relative to the standard service usage pattern.

19. The method according to claim 13, wherein the first time interval corresponds to one month or one week, and the second time interval is less than or equal to at least one of one second, one minute, one hour, and twenty-four hours.

20. The method according to claim 13, wherein the first time interval corresponds to one day, and the second time interval is less than or equal to at least one of one second, one minute, and one hour.

21. The method according to claim 13, wherein the method is further for charging the subscriber with respect to another telecommunications service in the telecommunications network, and the method further comprises:
transmitting, by the billing entity, further charging information to the data traffic management entity, wherein a further current upper data usage threshold is derived from the charging information, wherein the further current upper data usage threshold indicates a further current maximum level of data which can be used by the subscriber with respect to the another telecommunications service, and wherein the another telecommunications service has a further standard service usage pattern;
monitoring, by the data traffic management entity, the flow of data which is used by the subscriber with respect to the another telecommunications service and determining a further current data usage volume of the subscriber,
comparing, by the data traffic management entity, the further current data usage volume of the subscriber with the further current upper data usage threshold; and
modifying the further standard service usage pattern of the another telecommunications service if the further current data usage volume and the further current upper data usage threshold satisfy a further predetermined condition;
wherein the further current upper data usage threshold is updated based on a further purchased maximum data volume corresponding to the first time interval, and wherein the update interval of the further current upper data usage threshold is based on the second time interval.

22. A system for charging a subscriber using a telecommunications service in a telecommunications network according to a contract with respect to the telecommunications service, the system comprising:
a billing entity; and
a data traffic management entity;
wherein the billing entity is configured to transmit charging information to a data traffic management entity, wherein a current upper data usage threshold is derived from the charging information, wherein the current upper data usage threshold indicates a current maximum level of data which can be used by the subscriber with respect to the telecommunications service, and wherein the telecommunications service has a standard service usage pattern; and
wherein the data traffic management entity is configured to monitor the flow of data which is used by the subscriber with respect to the telecommunications service and determine a current data usage volume of the subscriber, and to compare the current data usage volume of the subscriber with the current upper data usage threshold;
wherein the standard service usage pattern of the telecommunications service is modified if the current data usage volume and the current upper data usage threshold satisfy a predetermined condition;
wherein the current upper data usage threshold is updated based on a purchased maximum data volume corresponding to a first time interval, wherein the update interval of the current upper data usage threshold is based on a second time interval, and wherein the second time interval is shorter than the first time interval

23. A system, comprising one or more non-transitory computer-readable media having instructions for charging a subscriber using a telecommunications service in a telecommunications network according to a contract with respect to the telecommunications service, the computer-executable instructions, when executed by one or more processors, causing the following steps to be performed:
transmitting, by a billing entity, charging information to a data traffic management entity, wherein a current upper data usage threshold is derived from the charging information, wherein the current upper data usage threshold indicates a current maximum level of data which can be used by the subscriber with respect to the telecommunications service, and wherein the telecommunications service has a standard service usage pattern;
monitoring, by the data traffic management entity, the flow of data which is used by the subscriber with respect to the telecommunications service and determining a current data usage volume of the subscriber,
comparing, by the data traffic management entity, the current data usage volume of the subscriber with the current upper data usage threshold; and
modifying the standard service usage pattern of the telecommunications service if the current data usage volume and the current upper data usage threshold satisfy a predetermined condition;
wherein the current upper data usage threshold is updated based on a purchased maximum data volume corresponding to a first time interval, wherein the update interval of the current upper data usage threshold is based on a second time interval, and wherein the second time interval is shorter than the first time interval.
